(19) United States
(12) Patent Application Publication
(10) Pub. No.: US 2012/0217677 A1
(43) Pub. Date: Aug. 30, 2012

(54) Boxless Casting Mold and Method for the Production Thereof

(75) Inventors: Joerg MEINBERG, Lauf (DE); Johann Schmitt, Pegnitz (DE)

(73) Assignee: KSB Aktiengesellschaft, Frankenthal (DE)

(21) Appl. No.: 13/434,942

(22) Filed: Mar. 30, 2012

Related U.S. Application Data
(63) Continuation of application No. PCT/EP2010/064411, filed on Sep. 29, 2010.

(30) Foreign Application Priority Data
Sep. 30, 2009 (DE) 10 2009 043 555.7

(51) Int. Cl. B29C 43/58; B29C 43/32

(52) U.S. Cl. 264/319; 425/408

(57) ABSTRACT

A boxless casting form which is separated horizontally and which is composed of a lower casting body (1)and an upper casting body (2). The casting bodies (1, 2) are formed of dry sand and define a casting cavity (9). Openings (3, 4) are introduced into the casting bodies (1, 2), and these openings (3, 4) are used to align the casting bodies horizontally and form a vertical guide passage for a rod-like guide element (5).

### CROSS REFERENCE TO RELATED APPLICATIONS

This application is a continuation of international patent application no. PCT/EP2010/064411, filed Sep. 29, 2010, designating the United States of America and published in German on Apr. 7, 2011 as WO 2011/039220 A1, the entire disclosue of which is incorporated herein by reference. Priority is claimed based on Federal Republic of Germany patent application no. DE 10 2009 043 555.7, filed Sep. 30, 2009, the entire disclosure of which is likewise incorporated herein by reference.

### BACKGROUND OF THE INVENTION

The present invention relates to a boxless, horizontally split casting mold comprising at least two mold bodies which are formed from a molding compound and delimit a casting cavity.

The production of castings requires a mold which is filled with liquid casting metal and in which the casting can solidify. The cavity of the mold is the negative reflection of the casting.

The liquid metal is supplied into the cavity of the casting mold via a feed line. In this respect, a distinction is made in principle between two variants of the casting material supply. In the first variant, the casting mold is cast by uphill casting, the casting material passing via a cup and a pouring channel into the mold for casting. In the second variant, the casting material is pressed from a melting crucible located underneath the casting mold into the casting mold via an ascension pipe.

It is possible to use either lost molds or permanent molds for the production of castings. Lost molds are destroyed when the casting is removed. These molds are formed from a molding compound. They usually consist of quartz sand in combination with a binder. Permanent molds are often used when castings of non-ferrous metals have to be produced in a large quantity. These molds are comprised of cast steel or ferrous materials or non-ferrous materials.

The invention relates to a lost casting mold. Lost casting molds may be boxless or else have a molding box which is composed of two molding-box halves. The invention deals with a boxless casting mold.

Boxless casting molds are usually two-part molds. They are used without upper and lower boxes. Molding frames are used merely for the production of the mold bodies and for precise centering of the upper and lower mold bodies, but are then removed again before the casting. For casting, what is known as a boxless mold is then obtained, this having the significant advantage that the very high investment costs for the molding boxes are no longer required.

Boxless casting molds are being used increasingly in foundry practice. The casting molds usually have a cuboid or cubic form and have a mold surface or two mold surfaces lying opposite one another, in which the models are molded. Two casting molds together provide a shape for the casting to be cast. The closed, boxless casting molds are placed alongside one another on a pouring line for casting. At the same time, a pouring cup and a pouring channel are concomitantly molded into the mold bodies, such that the casting can be started immediately after the mold bodies have been joined together to form the casting molds. The advantage of these boxless casting molds is that a molding box which consists of a lower box and an upper box is not required.

Before casting, the mold bodies have to be aligned and fixed securely with respect to one another. This alignment is very time-consuming.

### SUMMARY OF THE INVENTION

It is an object of the present invention to provide a boxless casting mold in which the mold bodies can be aligned with one another quickly and precisely.

According to the invention, this object is achieved in that two mold bodies lying opposite one another have openings and the openings form a vertical guide passage for a rod-like guide element for horizontally aligning the mold bodies.

The openings are preferably channels which run in the mold bodies. The channels can have different cross sections, with round cross sections proving to be particularly beneficial.

The openings are integrated in regions of the mold bodies where the latter are not connected to the casting cavity. To this end, it is preferable for the mold bodies to have protrusions in which the openings are made. These protrusions are targeted material accumulations of molding compound. Through-openings can be made in the material accumulations without the casting cavity being damaged as a result. The protrusions are formed by a material accumulation of molding compound on the side surfaces of the mold bodies. When the casting mold is closed, a cutout is formed between the protrusions in a number of embodiments of the invention. The rod-shaped guide element crosses through the cutout. Within the cutout, the guide element is not surrounded by a channel. The guidance is accomplished exclusively by the openings in the upper and lower mold bodies.

A through-channel is introduced at least into one of the two opposing mold bodies. The channel in the mold body counterpart can also protrude only into part of the mold body. In a preferred embodiment of the invention, through-channels are introduced into both mold bodies.

The rod-like guide element is preferably a metal rod with a round cross section. The diameter of the metal rod is adapted to the diameter of the openings. The diameter of the metal rod has to be slightly smaller than the diameter of the openings. It has proved to be particularly advantageous if a radial clearance of less than 1 mm, preferably less than 0.5 mm, is produced around the rod as a result. It is thereby possible for the rod to be introduced into the openings and moved, and for sufficiently precise guidance to be achieved nevertheless. The openings form a guide passage for the rod-shaped guide element. Linear guidance of the guide element is thereby achieved.

In one particularly advantageous embodiment of the invention, the rod-like guide element has a reduced diameter at its front end. It is preferable for the front end of the rod to be in the form of a conical tip. This facilitates insertion of the rod into the openings. In addition, it proves to be advantageous if at least one opening is formed with a funnel-like expansion on that side which faces toward the opposing mold body, in order to facilitate entry of the rod into the opening.

The openings form a vertical guide passage for horizontally aligning the mold bodies. The aim of the horizontal alignment is to position the mold bodies with respect to one another such that the two halves of the casting chamber are joined together correctly and thereby form the complete casting cavity, without the halves being horizontally displaced with respect to one another. To this end, the casting cavity has to produce the negative reflection of the cast part to be cast. The apparatus according to the invention prevents lateral displacement of the casting cavity halves and thus misalignment of the cast part. The use of the invention makes it possible to quickly horizontally align the mold bodies with respect to one another.

In a particularly advantageous embodiment of the invention, a mold body has a bead formed from molding compound. The bead forms the positive counterpart to a hollow or recess in the opposing mold body. This embodiment provides for precise guidance when the mold bodies are being joined together. In this case, the guide passage formed by the openings serves for pre-alignment, which has the effect that the bead fits into the recess. In the case of conventional casting molds, there is a risk that, when the mold bodies are being joined together, the bead is positioned displaced horizontally with respect to the recess. This can lead to the bead being damaged. The bead formed from molding compound can be destroyed by the pressure exerted on it as the mold bodies are being joined together.

The bead is preferably a geometric shape with a hemispherical end face and cylindrical side walls. The hemispherical form makes it easier for the bead to slide into the recess. The cylindrical side walls provide for precise guidance of the bead in the recess. In this case, the recess is in the form of a negative counterpart to the bead.

In a particularly advantageous embodiment of the invention, the openings are formed such that they form a guide passage for a connection element. The mold bodies can be clamped via the connection element by means of two counterparts. The connection element is preferably a metal rod which is provided with a thread. The thread can either run along the entire rod or be applied only to the two ends of the rod. The two mold bodies are preferably clamped with respect to one another by means of two clamping nuts, which are screwed onto the two ends of the rod. A plate-shaped surface presses against the mold material and urges the bodies together. In this case, either the clamping nut can be formed with a plate-shaped surface, or commercially available nuts can be used with a plate-shaped washer.

It is particularly advantageous if at least one counterpart is integrated in one of the mold bodies. To this end, a clamping nut can be introduced into a mold body. In this case, the plate-shaped surface of the clamping nut is enclosed by molding compound. The connection element is screwed into the clamping nut at one end and with its other end protrudes out of the opposing mold body. A second clamping nut is screwed onto the protruding end. By tightening the clamping nuts, the mold bodies are clamped to one another.

The invention also relates to a method for producing a casting mold according to the invention. In this method, molding compound is introduced into molding boxes and/or molding frames, these being rigid parts without bending and twisting for receiving and for retaining the molding compound compacted therein. The hardened molding compound is used in the form of ultimately strong mold bodies for sand casting. Such a sand mold consists of at least two mold parts. In the case of horizontally split casting molds, these are referred to as upper and lower bodies.

To produce the casting mold according to the invention, pins are positioned on the fastening elements in the production method according to the invention and make the openings in the mold bodies during the production of the mold bodies. According to the invention, the pins are arranged such that they place the openings such that they form a vertical guide passage for a rod-like guide element for horizontally aligning the mold bodies for two mold bodies lying opposite one another.

In one particularly advantageous embodiment of the invention, the pins are screwed onto the fastening elements.

### BRIEF DESCRIPTION OF THE DRAWINGS

The invention will be described in further detail hereinafter with reference to illustrative embodiments depicted in the accompanying drawing figures, in which:

FIG. 1a shows individual parts of a casting mold according to the invention;

FIG. 1b shows the alignment of the mold bodies by insertion of the rod-like guide element;

FIG. 1c shows a closed casting mold with a guide element;

FIG. 2 shows the clamping of the mold bodies by a connection element;

FIG. 3a shows a pin for lower mold bodies having a height of 220 mm;

FIG. 3b shows a pin for lower mold bodies having a height of 330 mm;

FIG. 4a shows a pin for upper mold bodies having a height of 220 mm;

FIG. 4b shows a pin for upper mold bodies having a height of 330 mm;

FIG. 5a is a side view showing a fastening element for mold bodies;

FIG. 5b is a plan view showing a fastening element for mold bodies, and

FIG. 6 shows a rod-like guide element.

### DETAILED DESCRIPTION OF ILLUSTRATIVE EMBODIMENTS

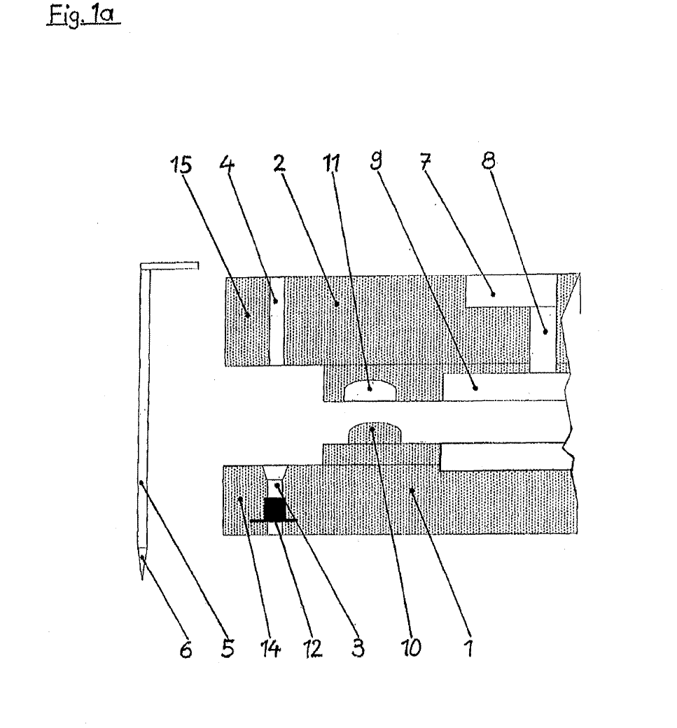

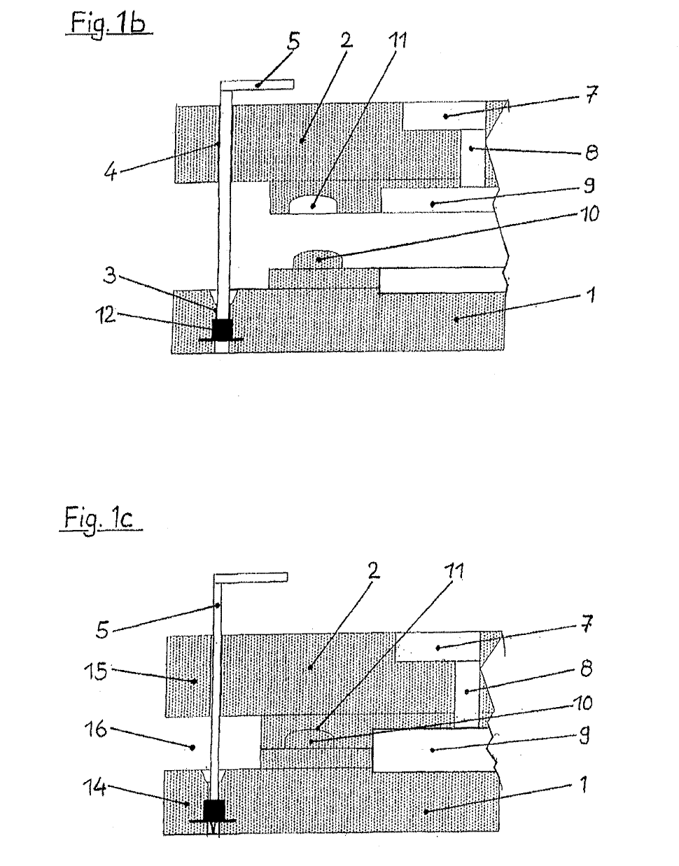

FIG. 1a shows individual parts of the casting mold according to the invention. The casting mold consists of a lower mold body 1 and an upper mold body 2. An opening 3 is made in the lower mold body 1. The upper mold body 2 comprises an opening 4. If the mold bodies 1, 2 are positioned correctly with respect to one another, the openings 3, 4 form a guide passage for the guide element 5. The front end of the guide element 5 is in the form of a conical tip 6. In the illustrative embodiment, the guide element 5 has a round cross section. The diameter of the guide element 5 is adapted to the diameter of the openings 3, 4. The conical tip 6 makes it easier to insert the guide element 5 into the opening 4 in the upper mold body 2.

A pouring basin 7 is formed in the upper mold body 2. The liquid melt is introduced into the pouring basin 7. The melt passes via a pouring channel 8 into a casting cavity 9, which is defined by the lower mold body 1 and the upper mold body 2. That side of the lower mold body 1 which faces toward the upper mold body 2 is provided with a bead 10. The bead 10 is formed from molding compound and is the positive counterpart to the recess 11 in the upper mold body 2.

Furthermore, a counterpart 12 for a connection element 13 (not shown in FIG. 1a) is integrated in the lower mold body 1. In the illustrative embodiment, the counterpart 12 is a clamping nut, which is embedded via a plate-shaped surface in the mold material. The opening 3 in the lower mold body 1 expands toward that side which faces toward the upper mold body 2. The lower mold body 1 has a protrusion 14 which is formed from a material accumulation. The upper mold body 2 has a protrusion 15 which is formed from a material accumulation. The openings 3, 4 are located in the protrusions 14, 15.

In FIG. 1b, the guide element 5 has been pushed through the opening 4 in the upper mold body 2 and protrudes into the opening 3 in the lower mold body 1.

The diameter of the internal thread of the counterpart 12 is greater than the external diameter of the guide element 5, and therefore the guide element can also be guided through the counterpart 12 and can move freely within the openings 3, 4 and within the counterpart 12. In the position shown in FIG. 1b, the mold bodies 1, 2 are aligned horizontally with respect to one another. To close the casting mold, the mold bodies 1, 2 only have to be displaced in the vertical direction with respect to one another. When the mold bodies 1, 2 are being joined together, the bead 10 enters the recess 11 as from a certain vertical approximation of the mold bodies 1, 2. That side of the bead 10 which faces toward the upper mold body 2 is in the form of a hemisphere, although any other form is also possible, for example a conical form. The side walls of the bead 10 and of the recess 11 have a cylindrical form here and serve for precise guidance as the mold bodies 1, 2 are being joined together.

FIG. 1c shows the casting mold in the closed position. The bead 10 fits seamlessly into the recess 11. The mold bodies 1, 2 define the casting cavity 9, which has the form of the workpiece to be produced. When the casting mold is closed, a cutout 16 is produced between the upper and lower mold bodies 2, 1 or between the protrusions 14, 15. The guide element 5 is visible within the cutout 16.

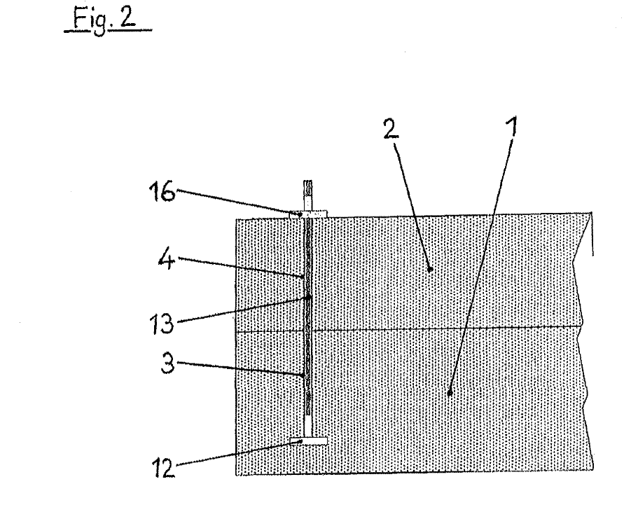

FIG. 2 shows a variant in which the mold bodies are without protrusions. Here, the openings 3, 4 are arranged directly in mold bodies 1, 2 which have been formed without protrusions. For reasons of better clarity, the pouring basin, pouring channel and casting cavity have not been shown here. In the casting mold shown in FIG. 2, a connection element 13 extends through the openings 3, 4. The mold bodies 1, 2 can be clamped by means of two counterparts 12, 16. In this illustrative embodiment, the connection element 13 is a metal rod, with a round cross section, which is provided with a thread at its ends. The counterparts 12, 16 are in the form of clamping nuts which are screwed by way of their internal thread to the ends of the connection element 13. The counterparts 12, 16 exert a contact pressure on the mold bodies 1, 2 by means of plate-shaped disks and thereby press the two halves of the casting mold together. In the illustrative embodiment, the counterpart 12 is integrated in the opening 3 in the lower mold body 1.

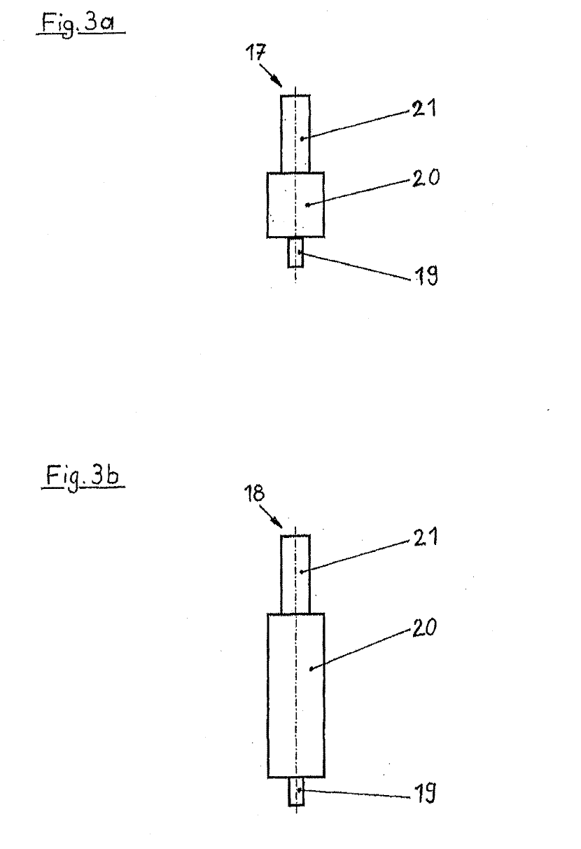

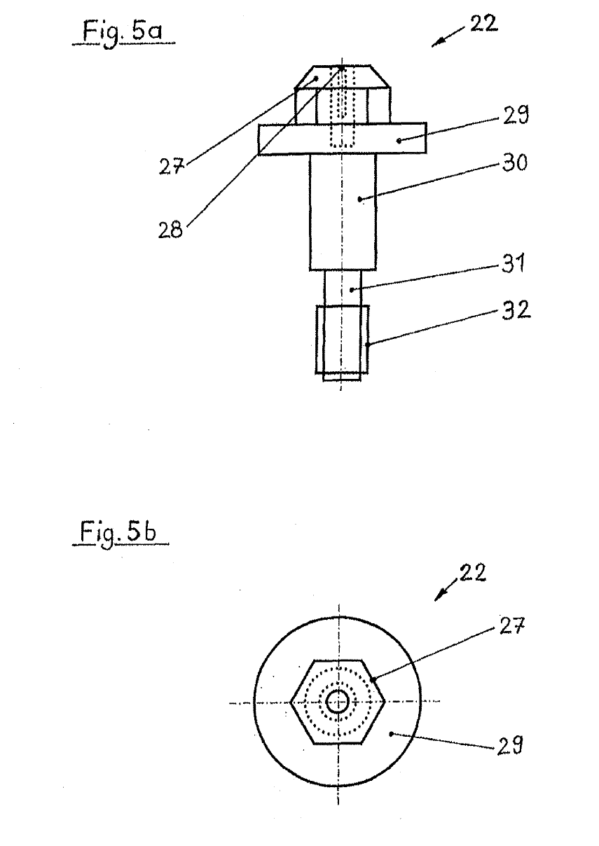

FIGS. 3a and 3b show pins 17, 18 for a lower mold body. The pin 17 is used for a lower mold body having a height of 220 mm. The pin 18 is used for a lower mold body having a height of 330 mm. The pins 17, 18 are composed of a lower segment 19, a middle segment 20 and an upper segment 21. In the illustrative embodiment, the segments 19, 20, 21 are in the form of cylindrical metal bodies which are connected fixedly to one another. The middle segment 20 has a greater diameter than the other two segments 19, 21. The lower segment 19 is provided with an external thread with which it can be screwed into an internal thread of a fastening screw 22 (shown in FIGS. 5a and 5b) of a molding box or molding frame for producing a mold body. The upper segment 21 produces the opening 3. The diameter of the upper segment 21 is adapted to the diameter of the guide element 5. The diameter of the upper segment here is slightly greater than the diameter of the guide element 5. In this illustrative embodiment, this difference in size is 1 mm, and therefore a radial clearance of 0.5 mm is produced when the guide element 5 is inserted into the opening 3.

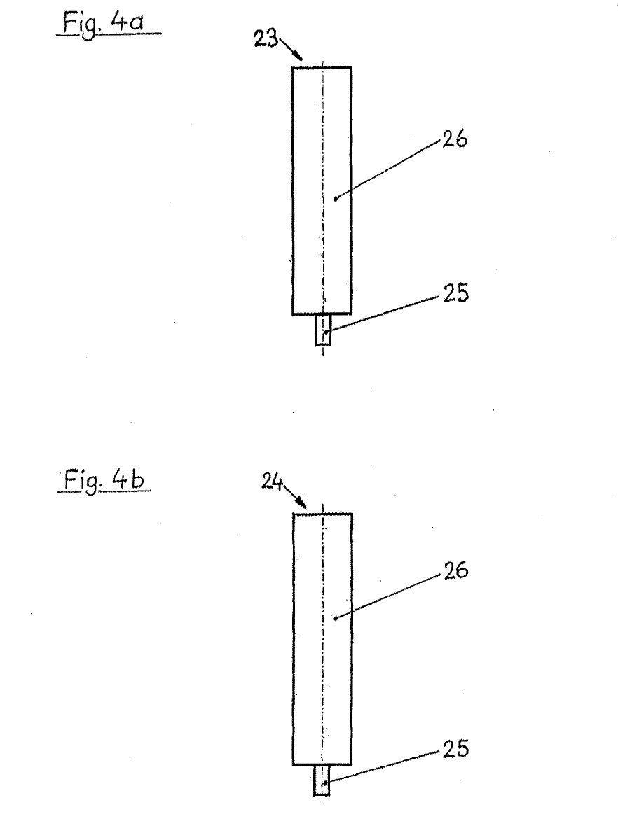

FIGS. 4a and 4b show the pins 23, 24 for producing an upper mold body. The pin 23 is used for an upper mold body having a height of 220 mm. The pin 24 is used for an upper mold body having a height of 330 mm. The pins 23, 24 are composed of a lower segment 25 and an upper segment 26. In the illustrative embodiment, the segments 25, 26 are in the form of cylindrical metal bodies which are connected fixedly to one another. The upper segment 26 has a greater diameter than the lower segment 25. The lower segment 25 is provided with an external thread with which it can be screwed into an internal thread of a fastening screw 22 (shown in FIGS. 5a and 5b) of a molding frame or molding box for producing a mold body. The upper segment 26 produces the opening 4. The diameter of the upper segment 26 is adapted to the diameter of the guide element 5. The diameter of the upper segment 26 here is slightly greater than the diameter of the guide element 5. In this illustrative embodiment, this difference in size is 1 mm, and therefore a radial clearance of 0.5 mm is produced when the guide element 5 is inserted into the opening 4.

FIG. 5a and FIG. 5b are side views showing a fastening screw 22 for producing the mold bodies. In FIG. 5a, the fastening screw is shown as a side view, and in FIG. 5b it is shown as a plan view. The head 27 of the fastening screw is composed of side walls and an upper part. The side walls form a hexagon. The upper part is beveled. A borehole with an internal thread 28 into which the lower segments 19, 25 of the pins 17, 18, 23, 24 can be screwed is formed in the head 27 of the fastening screw 22. The fastening screw 29 presses by way of a disk-shaped segment 29 against the mold bodies. A cylindrical segment 20 is arranged beneath the disk-shaped segment 29. The lower segment 31 of the fastening screw 22 is provided with an external thread onto which a sleeve 32 can be screwed.

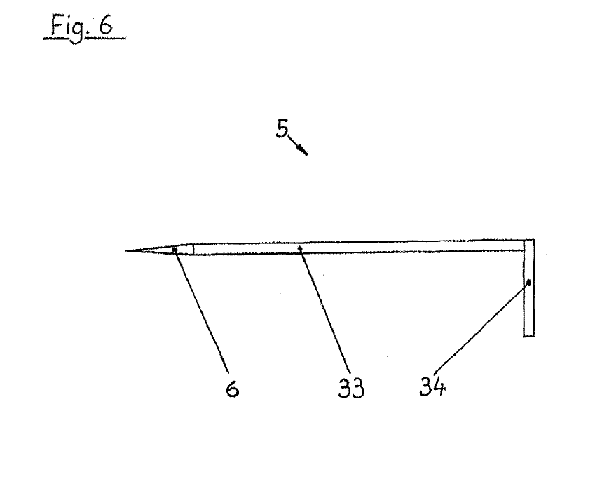

FIG. 6 shows the rod-like guide element 5. The front end of the guide element 5 is in the form of a conical tip 6. In this illustrative embodiment, the guide part 33 of the guide element 5 is in the form of a cylindrical body, which is adjoined by a handle 34. The handle 34 is at an angle with respect to the guide part 33.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variation within the scope of the appended claims and equivalents thereof.

1. A boxless, horizontally split casting mold comprising at least two mold bodies which are formed from a molding compound and define a casting cavity, wherein two of the at least two mold bodies are disposed opposite one another and are provided with openings, which openings form a vertical guide passage for a rod-like guide element for horizontally aligning the mold bodies.

2. The casting mold as claimed in claim 1, wherein the openings form a vertical guide passage for a connection element for clamping the mold bodies.

3. The casting mold as claimed in claim 2, wherein the mold bodies can be clamped via the connection element by means of two counterparts.

4. The casting mold as claimed in claim 3, wherein at least one counterpart is integrated within the opening of a mold body.

5. The casting mold as claimed in claim 1, wherein one mold body has a bead which is formed from molding compound and forms a positive counterpart to a recess in the opposite mold body.

6. The casting mold as claimed in claim 1, wherein the mold bodies have protrusions which are formed from a material accumulation of molding compound and in which the openings are integrated.

7. The casting mold as claimed in claim 6, wherein, when the casting mold is closed, a cutout is formed between the protrusions.

8. The casting mold as claimed in claim 1, wherein the rod-like guide element has a front end in the form of a conical tip.

9. The casting mold as claimed in claim 1, wherein at least one opening in one mold body is formed with a funnel-like expansion on that side which faces the opposite mold body.

10. A method for producing a boxless, horizontally split casting mold comprised of of at least two mold bodies which are formed from a molding compound, comprising:
Introducing molding compound into molding boxes or molding frames, and
clamping the molding boxes with fastening elements;
wherein
pins positioned on the fastening elements create openings in the mold bodies during production of the mold bodies, and
the pins are positioned such that the openings they create form a vertical guide passage for a rod-like guide element for horizontally aligning two mold bodies disposed opposite one another.

11. The method as claimed in claim 10, wherein the pins are screwed onto the fastening elements.
